(19) United States
(12) Patent Application Publication
(10) Pub. No.: US 2006/0062035 A1
(43) Pub. Date: Mar. 23, 2006

(54) Systemizer control enclosure

(76) Inventor: Timothy J. Cutler, Attleboro, MA (US)

Correspondence Address: Richard C. Litman;LITMAN LAW OFFICES, LTD., P.O. Box 15035, Arlington, VA, 22215, US

(21) Appl. No.: 10/921,825

(22) Filed: Aug. 20, 2004

(51) Int. Cl. H02M 1/00

(52) U.S. Cl. 363/144

(57) ABSTRACT

The systemizer control enclosure is provided in the form of a box having a top wall, a bottom wall, a left wall, a right wall, back wall and a front cover hinged to the right sidewall. An A.C. input power cord extends out of a cord connector mounted in the left wall. A sensor inlet opening is formed in the right wall for the sensor wiring. A.C. output power cords extend out of a plurality of strain-relief cord connectors in the bottom wall of the box for connection to the boilers, pumps or other heating system devices controlled by a typical boiler control unit. A component mounting plate is secured to an interior surface of the box. A boiler control unit, switching relays, a screw-down-terminal input/output wiring connector for connecting the wiring of the sensors to input terminals of the control unit the input and output power cords and a step-down transformer for supplying power to the boiler control unit and relays are pre-wired and mounted on the mounting plate.

### BACKGROUND OF THE INVENTION

1. Field of the Invention

The present invention relates to boiler controllers, and more specifically relates to a systemizer control enclosure for programmable boiler control units.

2. Description of the Related Art

Presently, electrical contractors are needed to wire current boiler controls having outdoor temperature reset, hot water production, radiant heat and all hot water applications, including hydro air. After heating contractors have installed the heating system components in a building, electricians must hard wire the appropriate sensors, boiler, pumps, control relays, etc., to the boiler control unit in order to complete the heating system installation process. The process is confusing in that it involves cooperation among different contractor. In addition, the process may be frustrating and very time consuming because of the number of components that must be wired or failures in coordinating the timing for the various contractors.

In the U S. Pat. No. 3,576,177 issued Apr. 27, 1971 to Block et al.; a multiple-boiler temperature control system having boiler sequencing, reverse firing, and individual boiler modulation with outdoor temperature reset is taught. The system includes an outdoor reset controller, transformer, and control relays operated by control motors all mounted on a single control panel. The system operates valves controlling the supply of fuel to a plurality of boilers for sequentially firing the boilers and thereafter reversing the firing order of the boilers. In this manner the total temperature-changing capacity output of all the boilers is controlled in response to temperature changing load requirements.

U.S. Pat. No. 4,527,246 issued Jul. 2, 1985 to Masson teaches a hot water heating system control device. The device continuously monitors the outside temperature and the actual water temperature and controls the operation of a boiler, pump and mixing valve to control the flow of hot water through the mixing valve into the circulation system to establish desired hot water temperatures which in turn create levels of warmth and comfort in a building. The mixing valve adjusts its openings in accordance with a predetermined reset ratio and offset adjustment setting controlled by a thumb wheel switch and a potentiometer. Relays are used to control operation of the pump, boiler and mixing valve in response to control signals from a microprocessor. The relays, input and output terminals, switches, display elements for programming the device, and display lights are mounted on a front plate of a control panel.

U.S. Pat. No. 5,779,143 issued Jul. 14, 1998 to Michaud et al. teaches a single hydronic control unit which performs a variety of desirable boiler functions and is contained in a single package having a single power connection. Signals from temperature sensors and thermostats are provided to the control unit that in turn controls the operation of zone valves for directing hot water to different heating zones in a house. The control unit also controls operation of the boiler burner and thus the water temperature in the boiler. The unit has a display face includes a digital display with LED readout for displaying the hot water temperature. The display face of the unit also includes control switches and dials along with LED's to indicate calls from the boiler, circulating pump and a priority device. Instead of controlling a plurality of valves, the unit may also control a plurality of circulating pumps that supply hot water to different heating zones in a structure.

None of the above inventions and patents, taken either singly or in combination, is seen to describe the instant invention as claimed.

### SUMMARY OF THE INVENTION

The present invention is a systemizer control enclosure for simplifying the process of installing hot water heating systems. The systemizer control enclosure includes all necessary relays and output wiring for supplying power to pumps, boilers and other heating system devices controlled by a boiler control unit. The required relays and sensors for the heating system are pre-wired to the boiler control unit within the enclosure. The enclosure is provided in the form of a box having a top wall, a bottom wall, a left wall, a right wall, back wall and a front cover hinged to the right sidewall. One end of an A.C. input power cord passes through a strain-relief cord connector in the left wall of the enclosure for connecting the enclosure to the 120V A.C. supply at an installation site. A sensor inlet opening is provided through the right wall for routing sensor wiring into the box. A.C. output power cords extend out of a plurality of strain-relief cord connectors mounted in the bottom wall of the enclosure for supplying 120 V.A.C. to the boilers, pumps or other heating system devices being controlled by the control unit. A component mounting plate is secured to an interior surface of the box. The boiler control unit, relays, and a screw-down-terminal input/output wiring connector are secured to the mounting plate. The wiring connector connects the wiring of the sensors to the input terminals of the control unit. A step-down transformer is also secured to the mounting plate for supplying 24V A.C. to the boiler control unit and relays. Installation of the enclosure consists of mounting the enclosure to a wall at the installation site, connecting the input power cord to an A.C. outlet at the installation site, and connecting the output power cords to the required heating system devices.

These and other FEATURES of the present invention will become readily apparent upon further review of the following specification and drawings.

### BRIEF DESCRIPTION OF THE DRAWINGS

FIG. 1 is an environmental, perspective view of a systemizer control enclosure according to the present invention.

FIG. 2 is a front view of the enclosure according to the present invention.

FIG. 3 is a side view of the enclosure from the right side.

FIG. 4 is a bottom view of the enclosure according to the present invention.

FIG. 5 is a top view of the control circuitry mounting plate of the enclosure according to the present invention.

FIG. 6 is a wiring diagram of the enclosure according to the present invention showing the pre-wired connections and a typical boiler control unit.

FIG. 7 is a wiring diagram of the relay circuit for supplying power to the output power cords of required heating system devices according to the present invention.

Similar reference characters denote corresponding features consistently throughout the attached drawings.

### DETAILED DESCRIPTION OF THE PREFERRED EMBODIMENT

The systemizer control enclosure of the present invention simplifies the installation process for hot water heating systems. The enclosure includes all necessary relays and A.C. outlets for supplying power to pumps, boilers and other heating system devices controlled by a boiler control unit. The boiler control unit, relays, system temperature sensors, power cords, etc., are all pre-wired within the enclosure.

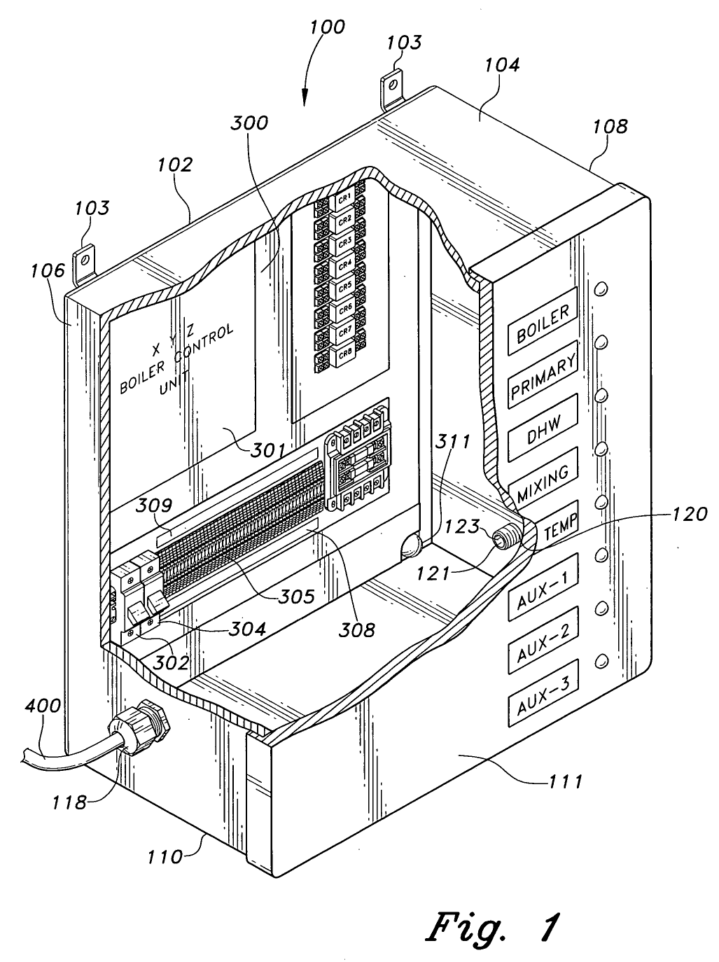

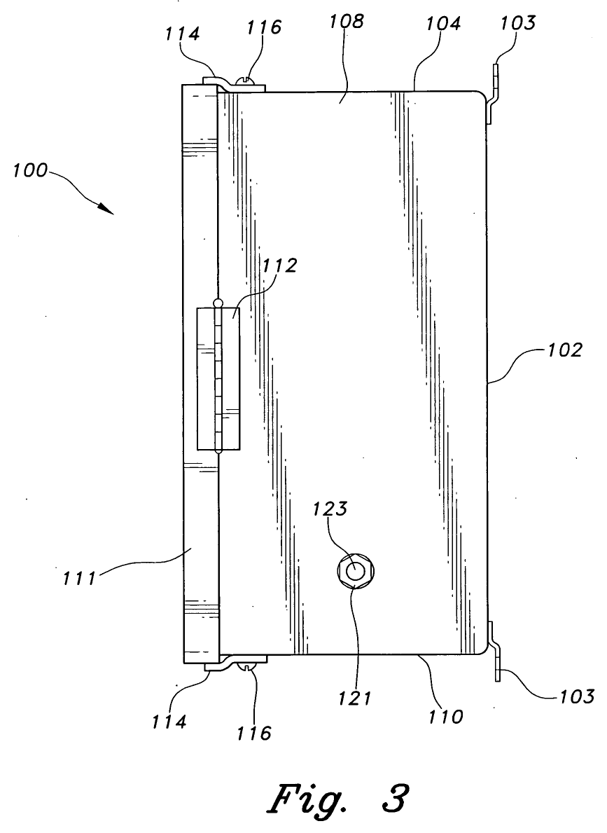

Referring generally to FIGS. 1-4, the systemizer control enclosure is provided in the form of a box 100 having a top wall 104, a bottom wall 110, a left sidewall 106, a right sidewall 108, back wall 102 and a front cover 112 pivotally attached by a hinge 113 to the right sidewall 108. The box is preferably formed from fiberglass, but may be formed any suitable corrosion resistant material.

An A.C. input power cord 400 extends from a strain-relief cord connector 118 mounted in a lower portion of the left sidewall 106 for connection to a 120V A.C. supply source at the installation site. A sensor inlet opening 120 is formed in right sidewall 108 and a threaded fastener 121 having a through hole 123 for the passage of sensor wiring there through is received within opening 120.

A.C. output power cords 500 extend through a plurality of strain-relief cord connectors 130, 135, 140, 145, 150, 155, 160 and 165 mounted in the bottom wall 110 of the box for supplying 120V A.C. to the boilers, pumps or other required heating system devices that are used in a particular installation of outdoor reset controls.

The strain-relief cord connectors are a non-metallic liquid-tight type like that manufactured by Arlington Ind., Inc. from Scranton, Pa. (U.S. Pat. No. 5,543,582). Preferred control units suitable for use with the enclosure include commercially available boiler control units from manufacturers such as Caleffi, Honeywell, Stadler Viega, Taco, Tekmar and Wersbo.

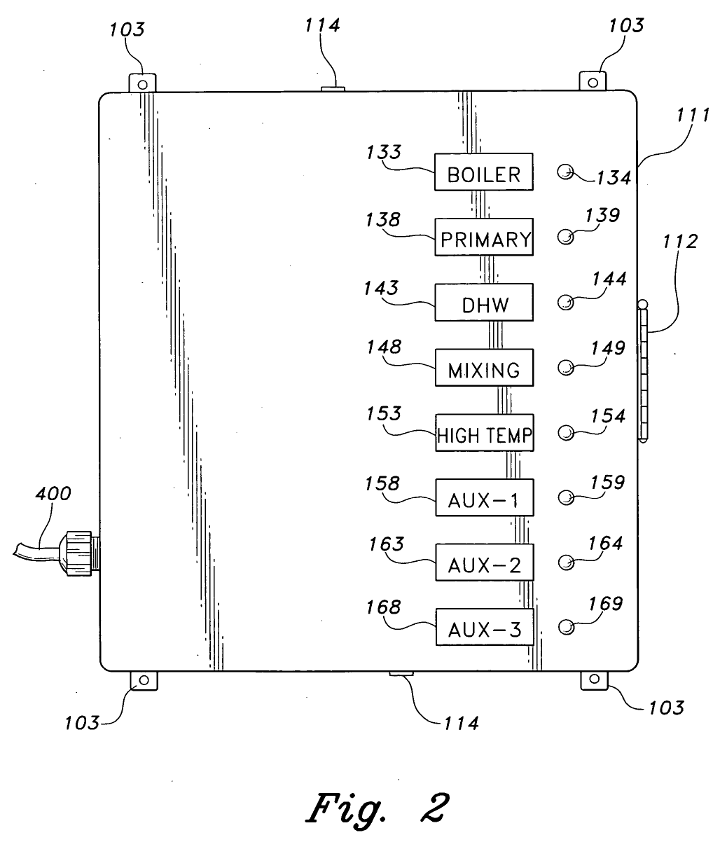

A first cover securing clip 114 is secured by a fastener 116 to top wall 104 adjacent a forward edge portion thereof and a second cover securing clip 114 is secured by a fastener 116 to a forward edge portion of bottom wall 110. Four wall mounting bracket 103 are affixed to the back wall 102. Brackets 103, as best seen in FIG. 2 are positioned adjacent each corner of the back wall 102 for securely mounting the box 100 to a wall at the installation site with threaded fastener elements.

FIG. 2 also shows a plurality indicator lamps 134, 139, 144, 149, 154, 159, 164 and 169 mounted along the right side of cover 111 for indicating the operating state of the required heating system devices connected to the power cords 500 passing through cord connectors 130, 135, 140, 145, 150, 155, 160 and 165, respectively. The indicator lamps are preferably in the form of LED's, however LCD's and miniature light bulbs are also suitable for use in the present invention. A plurality of vinyl indicator labels 133, 138, 143, 148, 153, 158, 163 and 168 are adhesively secured to cover 111 adjacent indicator lamps 134, 139, 143, 149, 153, 159, 163 and 169, respectively. Each label has indicia thereon indicative of a heating system device controlled by the enclosure.

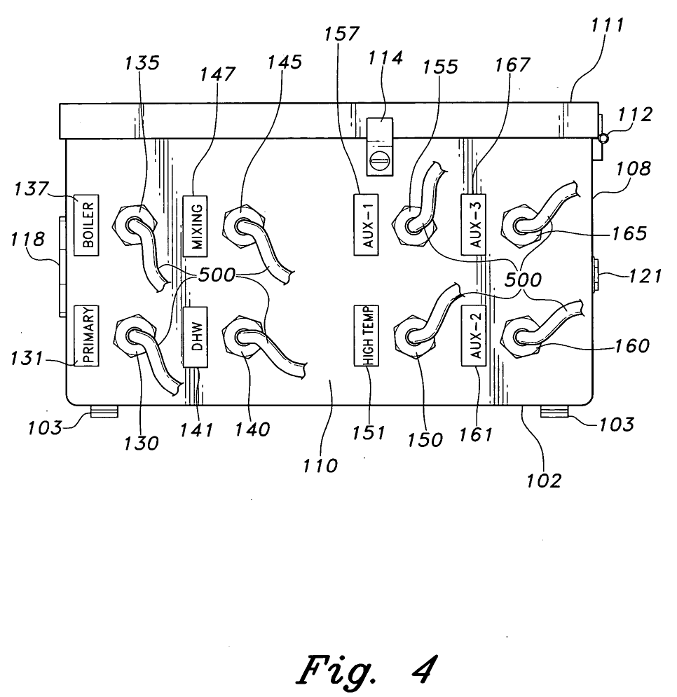

FIG. 4 shows the bottom wall 110 of box 100 where the output power cords 500 are fixed within the connectors 130, 135, 140, 145, 150, 155, 160 and 165. Corresponding vinyl indicator labels 131, 137, 141, 147, 151, 157, 161 and 167, respectively, are adhesively applied to the bottom wall 110 adjacent each output connector to identify to an installer which heating system devices are connected to each power cord for controlled operation by the boiler control unit 320.

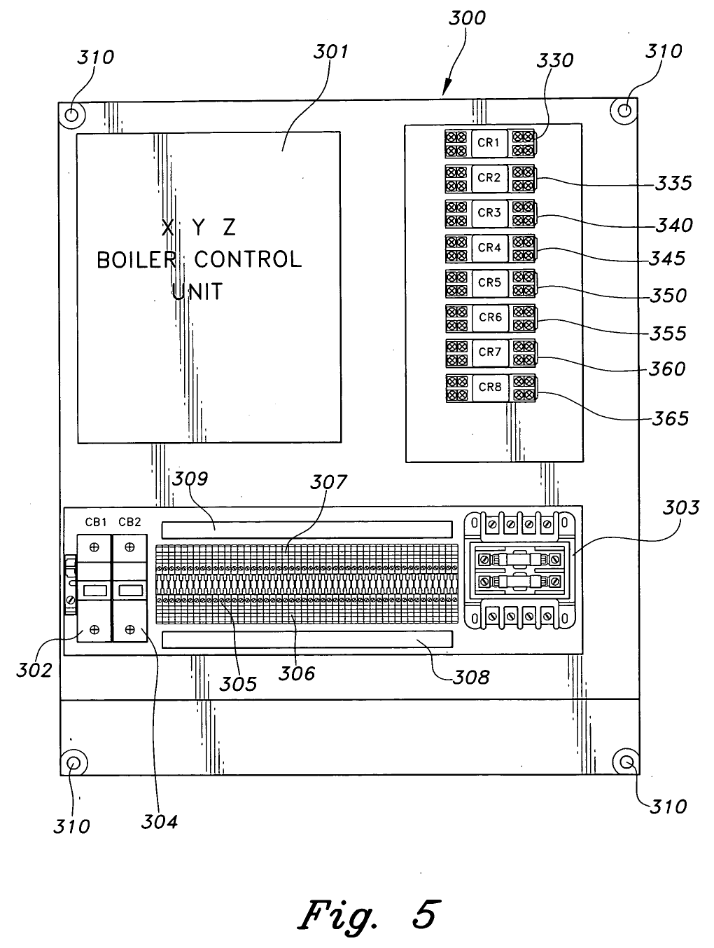

In FIG. 5, a component mounting plate 300 is shown, upon which, the electrical control components of the enclosure are mounted including a transformer 303 for supplying power to the enclosure components, a boiler control unit 320 for controlling the operation of the heating system devices, a circuit breaker 302 for the 120V A.C. input and a circuit breaker 304 for the 24V A.C. output from transformer 303. Control relays 330, 335, 340, 345, 350, 355, 360 and 365 are mounted on plate 300 and operatively connected to the control unit 320 and output power cords 500 fixed in connectors 130, 135, 140, 145, 150, 155, 160 and 165, respectively. Also mounted on plate 300 is a screw-down-terminal wiring connector 305 for connecting heating system sensor wiring to the boiler control unit 320. Attachment apertures 310 are formed on the corners of plate 300 for securing plate 300 to an interior surface of box 100 such as the back wall 102 as shown in FIG. 1.

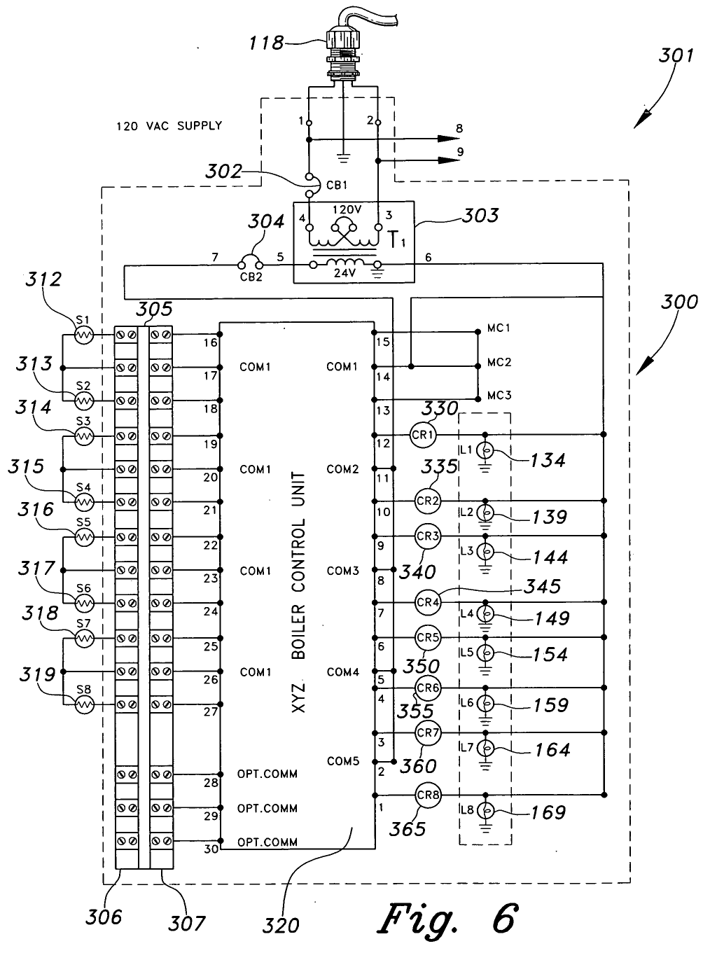

Turning now to FIG. 6, a wiring diagram 301 for box 100 is shown for a Honeywell boiler control unit. Temperature sensors 312-319 are shown connected to input terminal 306 of connector 305 while the output terminal are connected to control unit 320. As can be seen on the right side of FIG. 6, relays 330, 335, 340, 345, 350, 355, 360, and 365 are operatively connected for controlled actuation by control unit 320.

When any one or more of control relays 330, 335, 340, 345, 350, 355, 360, and 365 is actuated, an associated indicator lamp 134, 139, 144, 149, 154, 159, 164 and 169, respectively, is illuminated on cover 111 and A.C. power is provided to the associated heating system device by way of the power cords 500 in connectors 130, 135, 140, 145, 150, 155, 160 and 165, respectively. Connections 13-15 of the Honeywell control unit 320 shown in FIG. 6 are used for optional mixing control devices such as a variable speed circulator or a floating mixing valve.

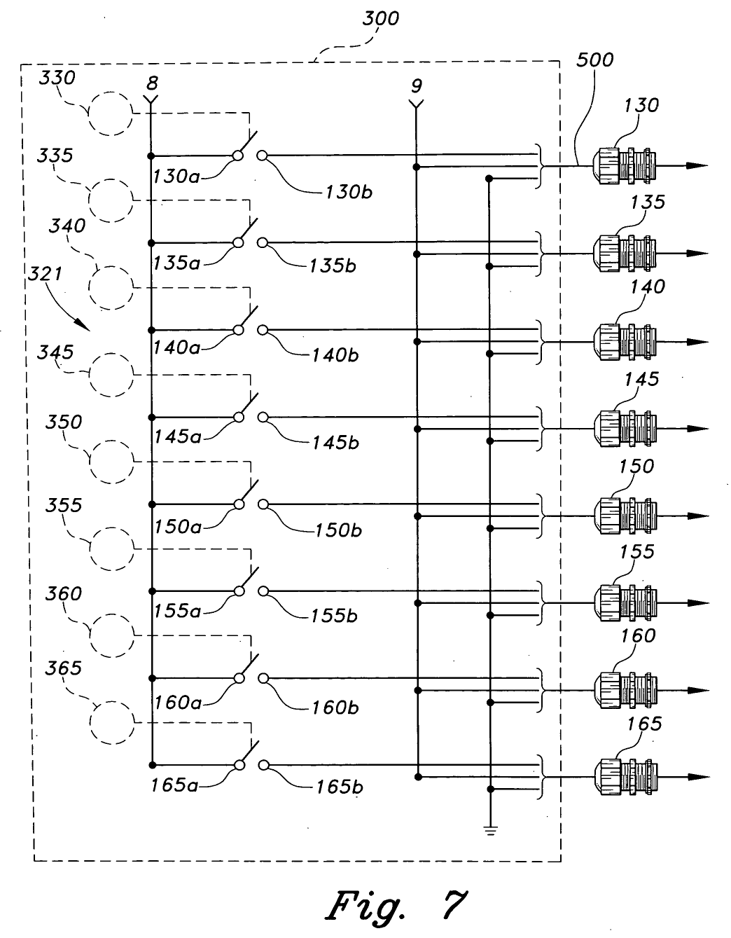

FIG. 7 shows that relays 330-365 have corresponding contacts 130a, 130b, 135a, 135b, 140a, 140b, 150a, 150b, 160a, 160b, 165a and 165b that connect wiring from the output power cords 500 to the 120V A.C. input supply of the box 100 for selective operation of the connected heating system devices.

All of the sensors and sensor wiring for a particular heating system are provided with the enclosure. The ends of the output power cords 500 wiring are stripped for hard wire connection to the relays 130, 135, 140, 145, 150, 155, 160 and 165, and to the heating system devices controlled by the control unit 320 of the box 100.

Using the enclosure as described above, installation consists of mounting the box 100 to a wall at an installation site; hard wiring the input power cord 400 to a 120V A.C. source at the installation site; and hard wiring the wires of the output power cords 500 to the appropriate heating system devices to complete installation.

It is to be understood that the present invention is not limited to the embodiment described above, but encompasses any and all embodiments within the scope of the following claims.

I claim:

1. A systemizer control enclosure, comprising:
a box having a top wall, a bottom wall, a left wall, a right wall, back wall and a front cover hinged to said right sidewall;
an A.C. input power cord fixed in a strain relief cord connector mounted on said left wall;
an inlet opening provided through said right wall for receiving sensor wiring;
a plurality of A.C. output power cords fixed in strain relief cord connectors mounted on said bottom wall for supply A.C. power to boilers, pumps or other required heating system devices;
a mounting plate secured to an interior surface of said box;
a commercially available boiler control unit;
a plurality of external sensors having wiring for connection to said boiler control unit;
a plurality of control relays mounted on said mounting plate for transferring A.C. power to said output power cords;
a step-down transformer mounted on said mounting plate for supplying power to said boiler control unit and relays; and
a screw down terminal input/output wiring connector mounted on said mounting plate for connecting said sensor wiring to input terminals of said control unit;
wherein said sensors, said input power cord and said output power cords are pre-wired within said enclosure.

2. The systemizer control enclosure according to claim 1, wherein said box is formed from fiberglass.

3. The systemizer control enclosure according to claim 1, further including:
a first cover securing clip fastened to said top wall; and
a second cover securing clip fastened to said bottom wall;
and a wall mounting bracket attached adjacent each corner of said back wall.

4. The systemizer control enclosure according to claim 3, further including a threaded fastener having a through hole mounted in said inlet opening.

5. The systemizer control enclosure according to claim 1, further including:
indicator lamps mounted adjacent one side of said cover and a lamp label positioned adjacent each said indicator lamp to display the name of a required heating system device; and
a connector label positioned on said bottom wall adjacent each said output connector having indicia for identifying which required heating system device should be connected to each of said output power cord.

6. The systemizer control enclosure according to claim 4, further including:
indicator lamps mounted adjacent one side of said cover and a lamp label positioned adjacent each said indicator lamp to display the name of a required heating system device; and
a connector label positioned on said bottom wall adjacent each said output connector having indicia for identifying which required heating system device should be connected to each of said output power cord.

7. The systemizer control enclosure according to claim 5, wherein said lamp labels and said connector labels are formed of vinyl.

8. The systemizer control enclosure according to claim 6, wherein said lamp labels and said connector labels are formed of vinyl.

9. The systemizer control enclosure according to claim 1, wherein each relay has contacts for controllably supplying 24 V. A.C power to illuminate an associated indicator lamp and supplying 120V A.C. power to said output power cords.

10. The systemizer control enclosure according to claim 4, wherein each relay has contacts for controllably supplying 24 V.A.C. power to illuminate an associated indicator lamp and supplying 120 V.A.C. power to said output power cords.

11. A systemizer control enclosure, comprising:
a box having a top wall, a bottom wall, a left wall, a right wall, back wall and a front cover hinged to said right sidewall;
an A.C. input power cord connector mounted on said left wall;
an inlet opening provided through said right wall for receiving sensor wiring;
a plurality of heating system sensors with wiring;
a commercially available boiler control unit from one of Caleffi, Honeywell, Stadler Viega, Taco, Tekmar and Wersbo manufacturers; a commercially available boiler control unit from Honeywell;
a plurality of output power cord connectors mounted on said bottom wall of said box;
a plurality of output power cords for supplying 120 Volts AC power to boilers, pumps or other required heating system devices controlled said boiler control unit;
a plurality of control relays for transferring 120 volts AC power to said output power cords;
a step-down transformer for supplying 24 Volts AC power to said boiler control unit and said relays;
a screw down terminal input/output wiring connector for connecting said sensor wiring to input terminals of said control unit;
a 24-volt AC circuit breaker;
a 120-volt Ac circuit breaker;
a mounting plate secured to an interior surface of said box;
wherein said boiler control unit, said transformer, said screw-down terminal wiring connector, said relays and said circuit breakers are operatively mounted on said mounting plate and said sensors, said input power cord and said output power cords are pre-wired within said enclosure.

12. The systemizer control enclosure according to claim 11, further including:
a first cover-securing clip fastened to said top wall;
a second cover securing clip fastened to said bottom wall; and
a wall mounting bracket attached adjacent each corner of said back wall.

13. The systemizer control enclosure according to claim 11, further including a threaded fastener having a through hole mounted in said inlet opening.

14. The systemizer control enclosure according to claim 11, further including:
indicator lamps mounted adjacent one side of said cover and a lamp label positioned adjacent each said indicator lamp to display the name of a required heating system device; and
a connector label positioned on said bottom wall adjacent each said output power cord connector, each connector label having indicia for identifying which required heating system device should be connected to each said output power cord;
wherein each relay has contacts for controllably supplying a 24V A.C power to illuminate an associated indicator lamp and supplying 120V A.C. power to an associated heating system device.

15. The systemizer control enclosure according to claim 13, further including:
indicator lamps mounted adjacent one side of said cover and a lamp label positioned adjacent each said indicator lamp to display the name of a required heating system device; and
a connector label positioned on said bottom wall adjacent each said output power cord connector, each connector label having indicia for identifying which required heating system device should be connected to each said output power cord;
wherein each relay has contacts for controllably supplying a 24V A.C power to illuminate an associated indicator lamp and supplying 120V A.C. power to an associated heating system device.

16. A systemizer control enclosure, comprising:
a fiberglass box having a top wall, a bottom wall, a left wall, a right wall, back wall and a front cover hinged to said right sidewall;
an input power cord connector mounted on said left wall;
a plurality of sensors;
an inlet opening provided through said right wall for receiving wiring from said sensors;
a commercially available boiler control unit from Honeywell;
a plurality of relays;
a plurality of output cord connectors mounted on said bottom wall;
a step-down transformer for supplying power to said boiler control unit and relays;
a screw down terminal input/output wiring connector for connecting said sensor wiring to input terminals of said control unit; and
a mounting plate secured to an interior surface of said box, wherein said boiler control unit, said wiring connector, relays, and said transformer are secured to said mounting plate.

17. The systemizer control enclosure according to claim 16, further including:
output power cords fixed in said output cord connectors and pre-wired to said enclosure for connecting each required heating system device, wherein the wiring of said output power cords are stripped at the ends for connection to the heating system devices; and
an input power cord fixed in said input cord connector for connecting said enclosure to a 120V A.C. supply at the installation site.

18. The systemizer control enclosure according to claim 17, wherein each said cord connector is a liquid-tight strain-relief cord connector.
